(19) United States
(12) Patent Application Publication
(10) Pub. No.: US 2026/0014539 A1
(43) Pub. Date: Jan. 15, 2026

(54) HOLLOW PARTICLES AND PRODUCTION METHOD THEREFOR

(71) Applicant: SANSUI CO., LTD., Saitama (JP)

(72) Inventors: Mamoru SAKAI, Saitama-shi (JP); Makoto SAKAI, Saitama-shi (JP)

(73) Assignee: SANSUI CO., LTD., Saitama (JP)

(21) Appl. No.: 19/100,763

(22) PCT Filed: Nov. 22, 2023
(86) PCT No.: PCT/JP2023/041902

§ 371 Date: Feb. 3, 2025

(30) Foreign Application Priority Data
Nov. 25, 2022 (JP) 2022-188012

(51) Int. Cl. B01J 13/18; B01J 13/20; C08F 12/08; C08F 12/36

(52) U.S. Cl. CPC B01J 13/185; B01J 13/203; C08F 12/08; C08F 12/36

(57) ABSTRACT

The present invention provides: hollow particles which enable a lower dielectric constant and a lower dielectric loss tangent of a resin composition and a production method therefor. The hollow particles of the present invention have a shell portion formed by a polymer of a monomer component including a divinyl aromatic compound and a monovinyl aromatic compound and a hollow portion surrounded by the shell portion, in which a dielectric loss tangent measured by cavity resonance method (frequency: 10 GHz (room temperature)) is 1.00×10⁻³ or less. The hollow particles can be produced by mixing the monomer component and a predetermined hydrophobic solvent, by further mixing water, by polymerizing the monomer component in an emulsion liquid obtained, and by washing a resulting polymer with water and an organic solvent.

### TECHNICAL FIELD

The present invention relates to hollow particles and a production method therefor. More specifically, the present invention relates to hollow particles which enable a lower dielectric constant and a lower dielectric loss tangent of a resin composition used as a material for electronic circuit boards, build-up boards, encapsulants, underfill materials, die-bond materials, and prepregs used in electronic devices for high-frequency communication systems for the 5th generation (5G) and beyond, and a production method therefor.

### BACKGROUND ART

Resin compositions containing a thermosetting resin such as an epoxy resin, a polyimide resin, a maleimide resin, or a phenol resin, or a thermoplastic resin such as a polyethylene resin, an acrylic resin, a polycarbonate resin, a polyarylate resin, or a fluorine resin are widely used as a material for electronic circuit boards, build-up boards, encapsulating materials, underfill materials, underfill materials, and prepregs, used in electronic devices. In particular, to compatible high-frequency communication systems for 5G and beyond, more excellent low dielectric properties are required, and various resin compositions have been developed in recent years.

Patent Document 1 discloses a resin composition, comprising a thermosetting resin and hollow particles, wherein the shell of the hollow particles has a monolayer structure comprising any of a polymer and copolymer of a cross-linkable monomer and of a copolymer of the cross-linkable monomer and a monofunctional monomer, wherein the average particle diameter of the hollow particles is 0.1 to 30 μm, wherein the shell thickness of the hollow particles is 0.01 to 4 μm, and wherein the volume ratio of the internal void to the total volume of the hollow particles is 40 to 80%.

Patent Document 2 discloses hollow polymeric microparticles consisting of a shell and a hollow portion, wherein the shell has a monolayer structure comprising a polymer or copolymer of at least one cross-linkable monomer, or a copolymer of at least one cross-linkable monomer and at least one monofunctional monomer.

### PRIOR ART DOCUMENTS

### Patent Documents

Patent Document 1: WO 2004/67638 A
Patent Document 2: JP 2002-80503 A

### SUMMARY OF THE INVENTION

### Problem to be Solved by the Invention

However, the hollow particles disclosed in Patent Documents 1 to 2 did not sufficiently have a lower dielectric constant and a lower dielectric loss tangent (especially a lower dielectric loss tangent), considering their use in electronic devices and the like compatible with high-frequency communication systems for the 5th generation (5G) and beyond.

Therefore, the object of the present invention is to provide hollow particles which enable a lower dielectric constant and a lower dielectric loss tangent of a resin composition and a production method therefor.

### Means of Solving the Problem

The present invention is a production method for hollow particles, which have a shell portion formed by a polymer of a monomer component comprising a divinyl aromatic compound and a monovinyl aromatic compound and a hollow portion surrounded by the shell portion, wherein a dielectric loss tangent measured by cavity resonance method (frequency: 10 GHz (room temperature)) is 1.00×10⁻³ or less, comprising:
(a) mixing the monomer component and a normal paraffinic solvent having a carbon number of 9 or more, isoparaffinic solvent, or naphthenic solvent as a hydrophobic solvent to obtain an oil-based mixture liquid;

(b) mixing the oil-based mixture liquid with water to obtain an emulsion liquid in which the oil-based mixture liquid is dispersed in the water;

(c) polymerizing the monomer component in the emulsion liquid to form the polymer encapsulating the hydrophobic solvent; and
(d) (d1) washing the polymer with water and (d2) washing the polymer with an organic solvent to remove the hydrophobic solvent encapsulated in the polymer.

The present invention is hollow particles, which have a shell portion formed by a polymer of a monomer component comprising a divinyl aromatic compound and a monovinyl aromatic compound and a hollow portion surrounded by the shell portion; wherein a dielectric loss tangent measured by cavity resonance method (frequency: 10 GHz (room temperature)) is 1.00×10⁻³ or less.

### Effect of the Invention

According to the present invention, it is possible to provide hollow particles which enable a lower dielectric constant and a lower dielectric loss tangent of a resin composition and a production method therefor.

### MODE FOR CARRYING OUT THE INVENTION

Hollow particles of the present invention have a shell portion formed by a polymer of a monomer component including a divinyl aromatic compound and a hollow portion surrounded by the shell portion. As described below, air is present in the hollow portion of the hollow particle, but almost no hydrophobic solvent (and also unreacted monomers, polymerization initiators, dispersion stabilizers, etc.) used during the production remains in the hollow portion. Such hollow particles have a low dielectric constant and a low dielectric loss tangent, which enable a lower dielectric constant and a lower dielectric loss tangent of a resin composition compounded with them.

A divinyl aromatic compound contained in a monomer component for synthesizing a polymer for forming a shell portion has two double bonds with low polarity. Therefore, the polymer obtained by polymerizing the divinyl aromatic compound is a polymeric cross-linked substance with low polarity, and the hollow particles formed from the polymer have a lower dielectric constant and a lower dielectric loss tangent. Examples of the divinyl aromatic compound include divinylbenzenes (including isomers such as o-divinylbenzene, m-divinylbenzene, and p-divinylbenzene), divinylbiphenyls (including isomers such as 4,4-divinylbiphenyl and 3,3′-divinylbiphenyl), and divinylnaphthalenes (including isomers such as 1,5-divinylnaphthalene and 1,3-divinylnaphthalene), as well as compounds in which at least one hydrogen atom of these aromatic rings is substituted with a substituent. Examples of the substituent include alkyl groups, alkoxy groups, and alkylthio groups with a carbon atom number of 1 to 10; aryl groups, aryloxy groups, and arylthio groups with a carbon atom number of 6 to 10; cycloalkyl groups with a carbon atom number of 3 to 10; halogen atoms; hydroxyl group; and mercapto group. Among these, divinylbenzenes (including isomers such as o-divinylbenzene, m-divinylbenzene, and p-divinylbenzene) are preferable. The divinyl aromatic compound can be used alone in one kind or in combination with two or more kinds.

The monomer component for synthesizing a polymer for forming a shell portion may be only a divinyl aromatic compound mentioned above, but preferably include a monomer which can be copolymerized with a divinyl aromatic compound. Since a polymer obtained by polymerizing a divinyl aromatic compound is a substance with low polarity, the monomer which can be copolymerized with the divinyl aromatic compound is preferably a monomer having a double bond with low polarity. Examples of the monomer which can be copolymerized with the divinyl aromatic compound include monovinyl aromatic compounds, monoolefin compounds, and diolefin compounds. Among these, monovinyl aromatic compounds are preferable. The monovinyl aromatic compounds have good copolymerizability with a divinyl aromatic compound and have one double bond with low polarity. Therefore, a polymer obtained by copolymerization with a divinyl aromatic compound is a polymer cross-linked substance with further low polarity, and the hollow particles formed by the polymer have a further lower dielectric constant and a further lower dielectric loss tangent. The monomer which can be copolymerized with the divinyl aromatic compound can be used alone in one kind or in combination with two or more kinds.

Examples of the monovinyl aromatic compound include styrene compounds such as styrene, α-methylstyrene, β-methylstyrene, 2-methylstyrene, 3-methylstyrene, 4-methylstyrene, α-ethylstyrene, β-ethylstyrene, 2-ethylstyrene, 3-ethylstyrene, 4-ethylstyrene, α-cyclopropylstyrene, β-cyclopropylstyrene, and 4-tert-butylstyrene; vinylnaphthalene compounds such as 1-vinylnaphthalene and 2-vinylnaphthalene; vinylbiphenyl compounds such as 4-vinylbiphenyl and 3-vinylbiphenyl. Among these, styrene compounds are preferable, and styrene is more preferable. The monovinyl aromatic compound can be used alone in one kind or in combination with two or more kinds.

The amount of the used monomer which can be copolymerized with a divinyl aromatic compound can be adjusted according to the purpose. However, from the viewpoint of demonstrating properties of the divinyl aromatic compound to be copolymerized, the amount of the used monomer is preferably 90 parts by weight or less in 100 parts by weight of the monomer component, is more preferably 70 parts by weight or less, and is further preferably 60 parts by weight or less. The use of the monomer which can be copolymerized with a divinyl aromatic compound is not required. However, from the viewpoint of achieving a further lower dielectric constant and a further lower dielectric loss tangent by copolymerization, the amount of the used monomer is preferably 10 parts by weight or more in 100 parts by weight of the monomer component, is more preferably 30 parts by weight or more, and is further preferably 40 parts by weight or more.

In the present invention, for example, an emulsion liquid in which the above-mentioned monomer component is dispersed in water as an oil phase is prepared, and the monomer component is suspension-polymerized to form hollow particles composed of the polymer of the monomer component. Specifically, first, a monomer component and a hydrophobic solvent are mixed to obtain an oil-based mixture liquid (step (a)). Next, the oil-based mixture liquid obtained is mixed with water to obtain an emulsion liquid in which the oil-based mixture liquid is dispersed in the water (step (b)). Then, the monomer component is polymerized in the emulsion liquid (step (c)). In this way, a shell portion formed by the polymer which encapsulates the hydrophobic solvent can be formed.

It is preferable that the hydrophobic solvent for preparing an oil-based mixture liquid containing a monomer component is capable of dissolving the monomer component and has low compatibility with a polymer (or a copolymer) of the monomer component. Preferable examples of the hydrophobic solvent include aliphatic hydrocarbon solvents such as normal paraffinic solvents (including n-alkanes having a carbon number less than 20), isoparaffinic solvents, and naphthenic solvents. Among these, normal paraffinic solvents having a carbon number of 9 or more, isoparaffinic solvents, and naphthenic solvents are more preferable. The hydrophobic solvent can be used alone in one kind or in combination with two or more kinds.

Examples of the n-alkane having a carbon number less than 20 include n-pentane, n-hexane, n-heptane, n-octane, n-nonane, n-decane, n-undecane, n-dodecane, n-tridecane, n-tetradecane, n-pentadecane, n-hexadecane, n-heptadecane, n-octadecane, and n-nonadecane. The carbon number of the n-alkane is preferably 9 or more. Examples of the normal paraffinic solvent include NORPAR 10, NORPAR 12, NORPAR 13, and NORPAR 15 (all are produced by Exxon Mobil Corporation, product name). Examples of the isoparaffin solvent include Isoper C, Isoper E, Isoper G, Isoper H, Isoper L, Isoper M, and Isoper V (all are produced by Exxon Mobil Corporation, product name). Examples of the naphthenic solvent include Exxol Hexane, Exxol Heptane, Exxol DSP80/100, Exxol D30, Exxol D40, Exxol D60, Exxol D80, Exxol D95, Exxol D110, and Exxol D130 (all are produced by Exxon Mobil Corporation, product name).

The compounding ratio of the monomer component and the hydrophobic solvent can be adjusted according to the purpose. However, from the viewpoint of sufficient polymerization of the monomer component, the amount of the monomer component to 100 parts by weight of the hydrophobic solvent is preferably 10 to 900 parts by weight and is more preferably 30 to 700 parts by weight.

A polymerization initiator to polymerize a monomer component is preferably mixed with the oil-based mixture liquid. It is preferable that the polymerization initiator is capable of initiating the polymerization of a divinyl aromatic compound (and a monomer copolymerized therewith) and is soluble in a hydrophobic solvent. Examples of the polymerization initiator include thermal radical polymerization initiators which can be cleaved by heat to generate radicals and photo radical polymerization initiators which can be cleaved by light to generate radicals. However, considering the suspension polymerization of the monomer component, thermal radical polymerization initiators are preferably used. Examples of the thermal radical polymerization initiator include organic peroxides such as benzoyl peroxide, lauroyl peroxide, cumene hydroperoxide, tert-butyl hydroperoxide, diisopropyl hydroperoxide, dicumyl peroxide, di-tert-butyl peroxide, and tert-butyl peroxybenzoate; azo compounds such as 2,2′-azobisisobutyronitrile, 2,2′-azobis-2-methylbutyronitrile, and 2,2′-azobis-2,4-dimethylvaleronitrile. Among these, organic peroxides are preferable, and benzoyl peroxide is more preferable. The polymerization initiator can be used alone in one kind or in combination with two or more kinds.

The compounding ratio of the polymerization initiator can be adjusted according to the purpose. However, from the viewpoint of sufficiently polymerizing the monomer component, the amount of the polymerization initiator to 100 parts by weight of the monomer component is preferably 0.1 to 5.0 parts by weight and is more preferably 0.3 to 3.0 parts by weight.

As water mixed with the oil-based mixture liquid to prepare the emulsion liquid, an ion-exchanged water is preferable. The oil-based mixture liquid can also be mixed with an aqueous mixture liquid compounded with a dispersion stabilizer to stably disperse the droplets of the oil-based mixture liquid in the water. Examples of the dispersion stabilizer include nonionic surfactants, anionic surfactants, cationic surfactants, amphoteric surfactants, and polymer-type surfactants. However, polymer-type surfactants are preferable. Examples of the polymer-type surfactant include polyvinyl alcohol surfactants (polyvinyl alcohol or modified bodies thereof), casein surfactants, carboxymethylcellulose surfactants, and acrylic surfactants. The dispersion stabilizer can be used alone in one kind or in combination with two or more kinds.

The compounding amount of the dispersion stabilizer can be adjusted according to the purpose. However, from the viewpoint of stable dispersion of droplets of the oil-based mixture liquid in water, the amount of the dispersion stabilizer to 100 parts by weight of the oil-based mixture liquid is preferably 1 to 30 parts by weight, is more preferably 3 to 20 parts by weight, and is further preferably 4 to 15 parts by weight.

For example, a homogenizer emulsifier can be used to mix an oil-based mixture liquid and water (or a water-based mixture liquid). The rotation speed and rotation time of the homogenizer emulsifier can be adjusted so as to form a state in which droplets of the oil-based mixture liquid with the desired size are dispersed in the water. By suspension polymerization of the monomer component in the emulsion liquid thus obtained, the polymer formed in the droplets of the oil-based mixture liquid moves or precipitates near the surface of the droplets (near the interface between the water and the oil-based mixture liquid) to form hollow particles with a shell portion made of the polymer. The temperature and the time of suspension polymerization can be adjusted so as to form the desired shell portion.

However, the shell portion composed of the resulting polymer encapsulates a hydrophobic solvent. Furthermore, unreacted monomers, polymerization initiators, dispersion stabilizers, etc. may remain. If these remain, the dielectric properties of the resulting hollow particles, especially the dielectric loss tangent, tend to be significantly higher. For example, Patent Documents 1 and 2 described that the hollow particles obtained by suspension polymerization are filtered and heat-dried, but this process cannot sufficiently remove a hydrophobic solvent, and the dielectric properties, especially the dielectric loss tangent, of the obtained hollow particles became significantly higher.

Therefore, in the present invention, the polymer obtained is washed to remove the hydrophobic solvent encapsulated in the polymer (step (d)). In this way, the hydrophobic solvent (and also unreacted monomers, polymerization initiators, dispersion stabilizers, etc.) encapsulated in the polymer can be sufficiently removed, and the resulting hollow particles can have a lower dielectric constant and a lower dielectric loss tangent.

In particular, it is preferable to wash the polymer with water (step (d1)) and wash the polymer with an organic solvent (step (d2)). Step (d1) and step (d2) are preferably performed multiple times (about 2 to 4 times), respectively. The organic solvents which are compatible with a hydrophobic solvent (and also unreacted monomers, polymerization initiators, dispersion stabilizers, etc.) can be used. Examples of the organic solvent include aliphatic hydrocarbons such as hexane, heptane, octane, cyclohexane; aromatic hydrocarbons such as benzene and toluene; nitrated hydrocarbons such as nitromethane and nitroethane; halogenated hydrocarbons such as methylene chloride, chloroform, methylene bromide, bromoform, methylene iodide, and iodoform; alcohols such as methyl alcohol, ethyl alcohol, and isopropyl alcohol; ethers such as diethyl ether and tetrahydrofuran; esters such as ethyl acetate; ketones such as acetone, methyl ethyl ketone, and methyl isobutyl ketone; and polar solvents such as dimethyl formamide and dimethyl sulfoxide. Among these, alcohols and/or ketones are preferable. The organic solvent can be used alone in one kind or in combination with two or more kinds. When step (d2) is performed multiple times, the same organic solvent may be used, or different organic solvents may be used. The washed hollow particles as mentioned above can also be dried by heating or reduced pressure, as appropriate.

In this way, it is possible to obtain hollow particles with high purity which have a shell portion formed by a polymer of a monomer component containing a divinyl aromatic compound and a hollow portion surrounded by the shell portion. Since air exists in the hollow portion of the hollow particles and almost no hydrophobic solvent used in the manufacture (and also unreacted monomers, polymerization initiators, dispersion stabilizers, etc.) remains, the hollow particles have a low dielectric constant and a low dielectric loss tangent, and the resin composition compounded with them can have a lower dielectric constant and a lower dielectric loss tangent.

The average particle diameter (median diameter) of the hollow particles is preferably 0.05 to 50 μm and is more preferably 0.1 to 30 μm. The average particle diameter (median diameter) of the hollow particles can be measured, for example, using a laser diffraction/scattering particle size distribution measuring device.

The average hollow ratio of the hollow particles is preferably 10 to 90% and is more preferably 20 to 80%. The hollow ratio of the hollow particle can be calculated by measuring the inner diameter and the outer diameter of the hollow particle with a scanning electron microscope or a transmission electron microscope and by using the following formula. For example, the average hollow ratio can be calculated from the hollow ratios of 10 or more randomly selected hollow particles.

Hollow ratio (%)=(inner diameter of hollow particle/outer diameter of hollow particle)³×100

The hollow ratio of a hollow particle can also be calculated by contrasting the sedimentary property with that of a particle formed of the same material which does not have a hollow portion (dense solid particle).

The dielectric loss tangent of the hollow particles measured by the cavity resonance method (frequency: 10 GHz (room temperature)) is usually equal to or less than the dielectric loss tangent of a silica (product name: spherical silica FB-950, produced by Denka Company Limited) measured under the same conditions immediately before or after. More specifically, the dielectric loss tangent is preferably 2.00×10⁻³ or less, is more preferably 1.80×10⁻³ or less, is further preferably 1.50×103 or less, and is especially preferably 1.00×10⁻³ or less. The dielectric constant of the hollow particles measured by the cavity resonance method (frequency: 10 GHz (room temperature)) is usually equal to or less than the dielectric constant of a silica (product name: spherical silica FB-950, produced by Denka Company Limited) measured under the same conditions immediately before or after. More specifically, the dielectric constant is preferably 3.30 or less.

Since the hollow particles of the present invention have a low dielectric constant and a low dielectric loss tangent, they can be compounded into a resin component used as a material for electronic circuit boards, build-up boards, encapsulants, underfill materials, die-bond materials, and prepregs used in electronic devices for high-frequency communication systems for the 5th generation (5G) and beyond, resulting that the resin compositions obtained have a lower dielectric constant and a lower dielectric loss tangent. Specific examples of the resin component include thermosetting resins such as epoxy resins, polyimide resins, maleimide resins, phenol resins; and thermoplastic resins such as polyethylene resins and fluororesins.

The resin composition can be obtained by mixing the above-mentioned hollow particles and a resin component. The compounding ratio can be adjusted so as to have the desired dielectric properties. However, the hollow particles are preferably compounded so that the content ratio of the hollow particles is 1 to 50 wt %. If the resin component is a thermosetting resin, it is preferable to cure it at room temperature or by heating after mixing.

Since the resin composition has a low dielectric constant and a low dielectric loss tangent, it is suitable as a material for electronic circuit boards, build-up boards, encapsulants, underfill materials, die-bond materials, and prepregs used in electronic devices for high-frequency communication systems for the 5th generation (5G) and beyond.

### EXAMPLES

### Example 1

A reaction apparatus, equipped with a stirrer, a 2-liter reaction vessel, a cooling tube (a condenser), a stirring blade, a thermometer, and an oil bath, was prepared. An oil-based mixture liquid was prepared by mixing 90 g of divinylbenzene (DVB, isomer mixture), 1.9 g of benzoyl peroxide (BPO, containing 25 wt % of water), and 90 g of Isopar M (produced by Exxon Mobil Corporation, product name, isoparaffin hydrocarbon compound). In addition, an aqueous mixture liquid was prepared by mixing 440 g of deionized water (H₂O) and 180 g of 10 wt % Kuraray Poval KL-506 (produced by Kuraray Co., Ltd., product name, modified polyvinyl alcohol, polymerization degree: about 600, saponification: 74 to 80 mol %) solution.

The above aqueous mixture liquid was provided in a 2-liter reaction vessel. Further, while adding the above oil-based mixture liquid thereto, the resultant mixture was emulsified at a rotational speed of 12,000 rpm for 2 minutes using a homogenizer emulsifier to obtain a milky white liquid. The resulting milky white liquid was set in the above reaction apparatus and was heated in the oil bath with stirring to a liquid temperature of 80° C. for about 4 hours, and was further heated to 93° C. for about 4 hours to carry out the polymerization reaction of divinylbenzene. As a result, a shell portion composed of a polymer obtained by polymerizing divinylbenzene was formed and the aqueous dispersion solution of hollow particle 1 was obtained, inside of which the hydrophobic solvent (Isopar M (product name)) as well as the dispersion stabilizer (Kuraray Poval KL-506 (product name)), the polymerization initiator (benzoyl peroxide), and the residual monomer (divinylbenzene) exist.

The aqueous dispersion was centrifuged in a high-speed centrifugal machine (Hitachi High-Technologies Corporation, product name: himac CR21G) at a rotational speed of 19,000 rpm and a centrifugal acceleration of 43,000 g to phase-separate hollow particles and a clear water phase, and the transparent water phase was removed. Deionized water was newly added to disperse the hollow particles, and then the phase separation was performed using the high-speed centrifuge under the same condition as described above to remove a clear aqueous phase. After that, similar washing steps were performed once with deionized water (twice in total), twice with isopropyl alcohol, once with methyl ethyl ketone, and once with acetone to remove the hydrophobic solvent which existed inside the hollow particles 1 as well as the dispersion stabilizer, the polymerization initiator, and the residual monomer. The resulting solids were then dried at 80° C. for about 24 hours to obtain a white powder of hollow particle 1.

The average particle diameter (median diameter at 50% frequency) of the obtained hollow particles 1 was measured using a laser diffraction/scattering particle size distribution analyzer (produced by HORIBA, Ltd., product name: LA-960), and was 4.1 μm. The hollow ratio (%)[=(inner diameter of hollow particle 1/outer diameter of hollow particle 1) 3×100] of 10 randomly selected hollow particles 1 was calculated from the inner diameters and the outer diameters of the hollow particle 1 measured with a scanning electron microscope, and the average was approximately 50%. Furthermore, the dielectric constant and the dielectric loss tangent of the obtained hollow particles 1 were measured by the cavity resonance method (frequency: 10 GHZ, room temperature), and the results are shown in Table 1.

### Example 2

White powder of hollow particles 2 was obtained in the same way as in Example 1, except that 67.5 g of divinylbenzene (DVB, isomer mixture) and 67.5 g of styrene (ST) were used instead of 90 g of divinylbenzene (DVB, isomer mixture), that the mixing amount of benzoyl peroxide (BPO, containing 25 wt % water) was 1.5 g, that the mixing amount of Isopar M (product name) was 135 g, the mixing amount of the deionized water was 330 g, and that the mixing amount of 10 wt % Kuraray Poval KL-506 (product name) aqueous solution was 190 g. The average particle diameter of the obtained hollow particles 2 was 2.9 μm, and the average hollow ratio was approximately 50%. The dielectric constant and the dielectric loss tangent of the obtained hollow particles 2 were measured and the results are shown in TABLE 1.

### Example 3

White powder of hollow particles 3 was obtained in the same way as in Example 2, except that Exxsol D40 (produced by Exxon Mobil Corporation, product name, naphthenic hydrocarbon compound) was used instead of Isopar M (product name). The average particle diameter of the obtained hollow particles 3 was 2.9 μm, and the average hollow ratio was approximately 50%. The dielectric constant and the dielectric loss tangent of the obtained hollow particles 3 were measured and the results are shown in TABLE 1.

### Example 4

White powder of hollow particles 4 was obtained in the same way as in Example 2, except that n-hexadecane (n-C₁₆H₃₄, normal paraffinic hydrocarbon compound) was used instead of Isopar M (product name). The average particle diameter of the obtained hollow particles 4 was 3.2 μm, and the average hollow ratio was approximately 50%. The dielectric constant and the dielectric loss tangent of the obtained hollow particles 4 were measured and the results are shown in TABLE 1.

### Example 5

White powder of hollow particles 5 was obtained in the same way as in Example 2, except that n-heptane (n-C₇H₁₆, normal paraffinic hydrocarbon compound) was used instead of Isopar M (product name). The average particle diameter of the obtained hollow particles 5 was 5.4 μm, and the average hollow ratio was approximately 50%. The dielectric constant and the dielectric loss tangent of the obtained hollow particles 5 were measured and the results are shown in TABLE 1.

### Example 6

White powder of hollow particles 6 was obtained in the same way as in Example 2, except that the washing step with an organic solvent (isopropyl alcohol, methyl ethyl ketone, and acetone) was not performed. The average particle diameter of the obtained hollow particles 6 was 2.9 μm, and the average hollow ratio was approximately 50%. The dielectric constant and the dielectric loss tangent of the obtained hollow particles 6 were measured and the results are shown in TABLE 1.

### Example 7

White powder of hollow particles 7 was obtained in the same way as in Example 2, except that the washing step with deionized water was not performed. The average particle diameter of the obtained hollow particles 7 was 2.9 μm, and the average hollow ratio was approximately 50%. The dielectric constant and the dielectric loss tangent of the obtained hollow particles 7 were measured and the results are shown in TABLE 1.

### Comparative Example 1

White powder of hollow particles C2 was obtained in the same way as in Example 2, except that the washing step was not performed. The average particle diameter of the obtained hollow particles C2 was 2.9 μm, and the average hollow ratio was approximately 50%. The dielectric constant and the dielectric loss tangent of the obtained hollow particles C2 were measured and the results are shown in TABLE 1.

### Comparative Example 2

White powder of hollow particles C3 was obtained in the same way as in Example 3, except that the washing step was not performed. The average particle diameter of the obtained hollow particles C3 was 2.9 μm, and the average hollow ratio was approximately 50%. The dielectric constant and the dielectric loss tangent of the obtained hollow particles C3 were measured and the results are shown in TABLE 1.

### Comparative Example 3

White powder of hollow particles C4 was obtained in the same way as in Example 3, except that the washing step was not performed. The average particle diameter of the obtained hollow particles C4 was 3.2 μm, and the average hollow ratio was approximately 50%. The dielectric constant and the dielectric loss tangent of the obtained hollow particles C4 were measured and the results are shown in TABLE 1.

### Comparative Example 4

The dielectric constant and the dielectric loss tangent of a commercially available silica (average particle diameter: 33.8 μm, produced by Denka Company Limited, product name: spherical silica FB-950) were measured and the results are shown in TABLE 1.

TABLE 1

| | | Example | | | | | |
|---|---|---|---|---|---|---|---|
| | | 1 | 2 | 3 | 4 | 5 | 6 |
| | hollow particles | 1 | 2 | 3 | 4 | 5 | 6 |
| amount | DBV | 90 | 67.5 | 67.5 | 67.5 | 67.5 | 67.5 |
| g | ST | | 67.5 | 67.5 | 67.5 | 67.5 | 67.5 |
| | BPO (25% H₂O) | 1.9 | 1.5 | 1.5 | 1.5 | 1.5 | 1.5 |
| | Isopar M | 90 | 135 | | | | 135 |
| | Exxsol D40 | | | 135 | | | |
| | n-C₁₆H₃₄ | | | | 135 | | |
| | n-C₇H₁₆ | | | | | 135 | |
| | H₂O | 440 | 330 | 330 | 330 | 330 | 330 |
| | 10% KL-506 aq. | 180 | 190 | 190 | 190 | 190 | 190 |
| washing | washing with water | yes | yes | yes | yes | yes | yes |
| | washing with organic solvent | yes | yes | yes | yes | yes | no |
| properties | average particle diameter [mm] | 4.1 | 2.9 | 2.9 | 3.2 | 5.4 | 2.9 |
| | average hollow ratio [%] | approx. 50 | approx. 50 | approx. 50 | approx. 50 | approx. 50 | approx. 50 |
| | dielectric constant | 1.513 | 1.525 | 1.484 | 1.505 | 1.540 | 1.538 |
| | ratio decreased from Comp. Ex. 4 | 54% | 54% | 55% | 54% | 53%. | 53%. |
| | ratio decreased by washing | — | 2.3% | 0.6% | 0.3% | — | 1.5% |
| | dielectric loss tangent [×10⁻³] | 1.52 | 0.627 | 0.866 | 0.763 | 1.48 | 1.62 |
| | ratio decreased from Comp. Ex. 4 | 24% | 69% | 57% | 62% | 26%. | 19% |
| | ratio decreased by washing | — | 72% | 60% | 62% | — | 28% |

| | | Example | Comparative Example | | | |
|---|---|---|---|---|---|---|
| | | 7 | 1 | 2 | 3 | 4 |
| | hollow particles | 7 | C2 | C3 | C4 | — |
| amount | DBV | 67.5 | 67.5 | 67.5 | 67.5 | |
| g | ST | 67.5 | 67.5 | 67.5 | 67.5 | |
| | BPO (25% H₂O) | 1.5 | 1.5 | 1.5 | 1.5 | |
| | Isopar M | 135 | 135 | | | |
| | Exxsol D40 | | | 135 | | |
| | n-C₁₆H₃₄ | | | | 135 | |
| | n-C₇H₁₆ | | | | | |
| | H₂O | 330 | 330 | 330 | 330 | |
| | 10% KL-506 aq. | 190 | 190 | 190 | 190 | |
| washing | washing with water | no | no | no | no | |
| | washing with organic solvent | yes | no | no | no | |
| properties | average particle diameter [mm] | 2.9 | 2.9 | 2.9 | 3.2 | 23.9 |
| | average hollow ratio [%] | approx. 50 | approx. 50 | approx. 50 | approx. 50 | dense |
| | | | | | | solid |
| | dielectric constant | 1.541 | 1.561 | 1.493 | 1.510 | 3.301 |
| | ratio decreased from Comp. Ex. 4 | 53%. | 53%. | 55% | 54% | — |
| | ratio decreased by washing | 1.3% | — | — | — | — |
| | dielectric loss tangent [×10⁻³] | 1.78 | 2.26 | 2.16 | 2.03 | 2.00 |
| | ratio decreased from Comp. Ex. 4 | 11%. | increased | increased | increased | — |
| | ratio decreased by washing | 21%. | — | — | — | — |

Both the dielectric constant and the dielectric loss tangent of the hollow particles 1 to 7 obtained in Examples 1 to 7 were lower than those in Comparative Example 4. In particular, although the hollow particles C2 to C4 obtained in Comparative Examples 1 to 3, in which the washing step was not performed, had a lower dielectric constant but had a higher dielectric loss tangent than that in Comparative Example 4, the hollow particles 2 to 4 obtained in Examples 2 to 4, in which the washing steps both with water and with an organic solvent were performed under the same condition, had a further lower dielectric constant and a significantly lower dielectric loss tangent than those of the corresponding hollow particles C2 to C4.

Although the hollow particles 6 obtained in Example 6 (only the washing step with water was performed) and the hollow particles 7 obtained in Example 7 (only the washing step with an organic solvent was performed) had a lower dielectric constant and a lower dielectric loss tangent than those of the hollow particles C2 obtained in Comparative Example 1 (the washing step was not performed) and than those in Comparative Example 4 (dense solid particles), the hollow particles 2 obtained in Example 2 (the washing steps both with water and with an organic solvent were performed) had a further much lower dielectric constant and a further much lower dielectric loss tangent (especially, a further much lower dielectric loss tangent) than those of the hollow particles 6 and 7.

This specification discloses at least the following inventions:
[1] A production method for hollow particles, which has a shell portion formed by a polymer of a monomer component comprising a divinyl aromatic compound and a hollow portion surrounded by the shell portion, comprising:
   (a) mixing the monomer component and a hydrophobic solvent to obtain an oil-based mixture liquid;
   (b) mixing the oil-based mixture liquid with water to obtain an emulsion liquid in which the oil-based mixture liquid is dispersed in the water;
   (c) polymerizing the monomer component in the emulsion liquid to form the polymer encapsulating the hydrophobic solvent; and
   (d) washing the polymer to remove the hydrophobic solvent encapsulated in the polymer.
[2] The production method according to [1],
   wherein the hydrophobic solvent is a normal paraffinic solvent, isoparaffinic solvent, or naphthenic solvent.
[3] The production method according to [1] or [2],
   wherein the divinyl aromatic compound is divinylbenzene.
[4] The production method according to any one of [1] to [3],
   wherein the monomer component further comprises monovinyl aromatic compound is styrene.
[5] The production method according to [4],
   wherein the monovinyl aromatic compound is styrene.
[6] The production method according to any one of [1] to [5], comprising as the step (d):
   (d1) washing the polymer with water,
   (d2) washing the polymer with an organic solvent.
[7] The production method according to [6],
   wherein the organic solvent is an alcohol and/or a ketone.
[8] Hollow particles, which have a shell portion formed by a polymer of a monomer component comprising a divinyl aromatic compound and a hollow portion surrounded by the shell portion;
   wherein a dielectric loss tangent measured by cavity resonance method (frequency: 10 GHz (room temperature)) is 1.00×10⁻³ or less.
[9] The hollow particles according to [8],
   wherein a dielectric constant measured by cavity resonance method (frequency: 10 GHz (room temperature)) is 3.30 or less.
[10] The hollow particles according to [7] or [8],
   wherein the divinyl aromatic compound is divinylbenzene.
[11] The hollow particles according to any one of [7] to [9],
   wherein the monovinyl aromatic compound is styrene.

1. A production method for hollow particles, which have a shell portion formed by a polymer of a monomer component comprising a divinyl aromatic compound and a monovinyl aromatic compound and a hollow portion surrounded by the shell portion, wherein a dielectric loss tangent measured by cavity resonance method (frequency: 10 GHz (room temperature)) is 1.00×10⁻³ or less, comprising:
(a) mixing the monomer component and a normal paraffinic solvent having a carbon number of 9 or more, isoparaffinic solvent, or naphthenic solvent as a hydrophobic solvent to obtain an oil-based mixture liquid;
(b) mixing the oil-based mixture liquid with water to obtain an emulsion liquid in which the oil-based mixture liquid is dispersed in the water;
(c) polymerizing the monomer component in the emulsion liquid to form the polymer encapsulating the hydrophobic solvent; and
(d) (d1) washing the polymer with water and (d2) washing the polymer with an organic solvent to remove the hydrophobic solvent encapsulated in the polymer.

2. The production method according to claim 1,
wherein the divinyl aromatic compound is divinylbenzene.

3. The production method according to claim 1,
wherein the monovinyl aromatic compound is styrene.

4. The production method according to claim 1,
wherein step (d1) and step (d2) are each performed multiple times in step (d).

5. The production method according to claim 1,
wherein the organic solvent is an alcohol and/or a ketone.

6. The production method according to claim 1,
wherein a dielectric constant measured by cavity resonance method (frequency: 10 GHZ (room temperature)) is 3.30 or less.

7. Hollow particles, which have a shell portion formed by a polymer of a monomer component comprising a divinyl aromatic compound and a monovinyl aromatic compound and a hollow portion surrounded by the shell portion;
wherein a dielectric loss tangent measured by cavity resonance method (frequency: 10 GHz (room temperature)) is 1.00×10−3 or less.

8. The hollow particles according to claim 7,
wherein a dielectric constant measured by cavity resonance method (frequency: 10 GHZ (room temperature)) is 3.30 or less.

9. The hollow particles according to claim 7,
wherein the divinyl aromatic compound is divinylbenzene.

10. The hollow particles according to claim 7,
wherein the monovinyl aromatic compound is styrene.
